(19) United States
(12) Patent Application Publication
(10) Pub. No.: US 2015/0074275 A1
(43) Pub. Date: Mar. 12, 2015

(54) MOBILE APPLICATION DATA STORAGE ALLOCATION

(71) Applicant: International Business Machines Corporation, Armonk, NY (US)

(72) Inventors: Paul A. Ashley, Queensland (AU); Anthony M. Butler, Dubai (AE); Ravi Kothari, New Delhi (IN); Yu-Chen Lin, New Taipei City (TW)

(73) Assignee: International Business Machines Corporation, Armonk, NY (US)

(21) Appl. No.: 14/022,419

(22) Filed: Sep. 10, 2013

(51) Int. Cl. H04L 12/911

(52) U.S. Cl. CPC H04L 47/70
USPC 709/226

(57) ABSTRACT

In a method for allocating and storing application data for applications of mobile devices, one or more processors receive one or more portions of application data of an application selected by a user of a mobile computing device. The one or more processors determine where to store each of the one or more portions of application data based on predefined instructions. The one or more processors cause each of the one or more portions of application data to be stored based on the determination.

### FIELD OF THE INVENTION

The present invention relates generally to mobile applications, and more particularly to storage allocation of application data.

### BACKGROUND OF THE INVENTION

A mobile application is a software application designed to operate on smart phones, tablet computers, and other mobile devices. Some applications are available for download for free, while others must be purchased. When an application is selected or purchased for download, it is downloaded from the application distribution program to the mobile device. There are a wide range of mobile applications, including mobile games, weather information, and ticket purchasing.

Many smart phones contain built-in near field communication (NFC) chips that allow the phone to send data over a short distance. An NFC chip contains information that can be read by any device capable of detecting it. Many retail stores and merchant account services are incorporating this technology into cash registers and credit card readers. A user of a smart phone may run an NFC application on the subscriber identity module (SIM) card of the smart phone.

Trusted Services Management (TSM) is a set of technologies that supports activities generally related to transferring information to a secure element, such as a SIM card, on a mobile computing device. TSM services may be used to transfer application data for a mobile application from an application provider to a smart phone. TSM services may also be used to transfer payment information between a smart phone and application provider.

### SUMMARY

Aspects of embodiments of the present invention disclose a method, computer program product, and computer system for allocating and storing application data for applications of mobile devices. One or more processors receive one or more portions of application data of an application selected by a user of a mobile computing device. The one or more processors determine where to store each of the one or more portions of application data based on predefined instructions. The one or more processors cause each of the one or more portions of application data to be stored based on the determination.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operation steps of a trusted services manager program, executing within a cloud server of the distributed data processing environment of FIG. 1, for determining the allocation of application data of the application selected for download by a user, in accordance with one embodiment of the present invention.

FIG. 3 depicts a block diagram of the components of the mobile computing device, application provider, and cloud server, in accordance with one embodiment of the present invention.

### DETAILED DESCRIPTION

Cloud computing is a growing trend in the information technology industry. Cloud computing is a colloquial expression used to describe a variety of different computing concepts that involve a large number of computers that are connected through a real-time communication network, such as the internet. For example, cloud computing may be a synonym for distributed computing over a network. Cloud computing relies on sharing of resources to achieve coherence and economies of scale similar to a utility over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the abovementioned. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

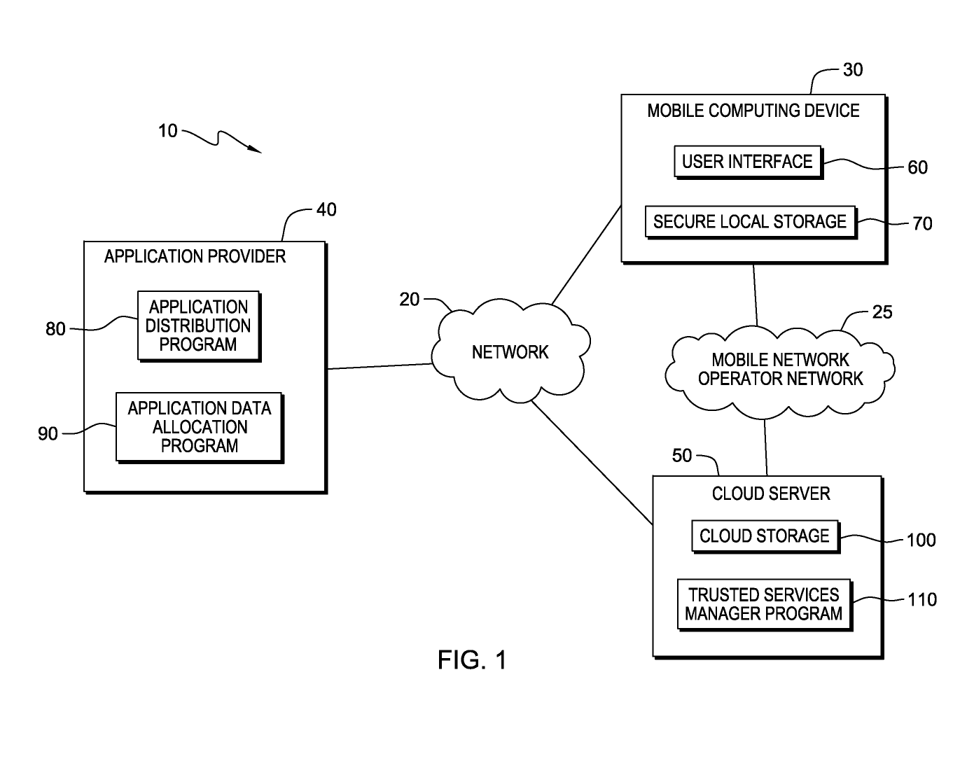

The present invention will now be described in detail with reference to the Figures. FIG. 1 depicts a diagram of distributed data processing environment 10 in accordance with one embodiment of the present invention. FIG. 1 provides only an illustration of one embodiment and does not imply any limitations with regard to the environments in which different embodiments may be implemented.

Distributed data processing environment 10 includes mobile computing device 30 and cloud server 50 interconnected over mobile network operator (MNO) network 25, and mobile computing device 30, application provider 40 and cloud server 50 interconnected over network 20. Network 20 may be a local area network (LAN), a wide area network (WAN) such as the Internet, a wireless internet provided by a third or fourth generation of mobile phone mobile communication, a combination of the three or any combination of connections and protocols that will support communications between mobile computing device 30, application provider 40, and cloud server 50 in accordance with embodiments of the invention. Network 20 may include wired, wireless, or fiber optic connections. Distributed data processing environment 10 may include additional server computers, client computers, or other devices not shown.

MNO network 25 may be wireless internet provided by a third or fourth generation of mobile phone mobile communication. A mobile network operator provides a secure mobile network (e.g. MNO network 25) for communication between cloud server 50 and mobile computing device 30. MNO network 25 may represent a series of cellular radio towers that operate to provide fourth generation (i.e. 4G wireless technology) mobile phone mobile communication. 4G wireless technology utilizes orthogonal frequency-division multiplexing (OFDM). OFDM functions by splitting radio signals into several narrow channels. The channels operate over different frequencies, which keep a user's data separate from other users on the network.

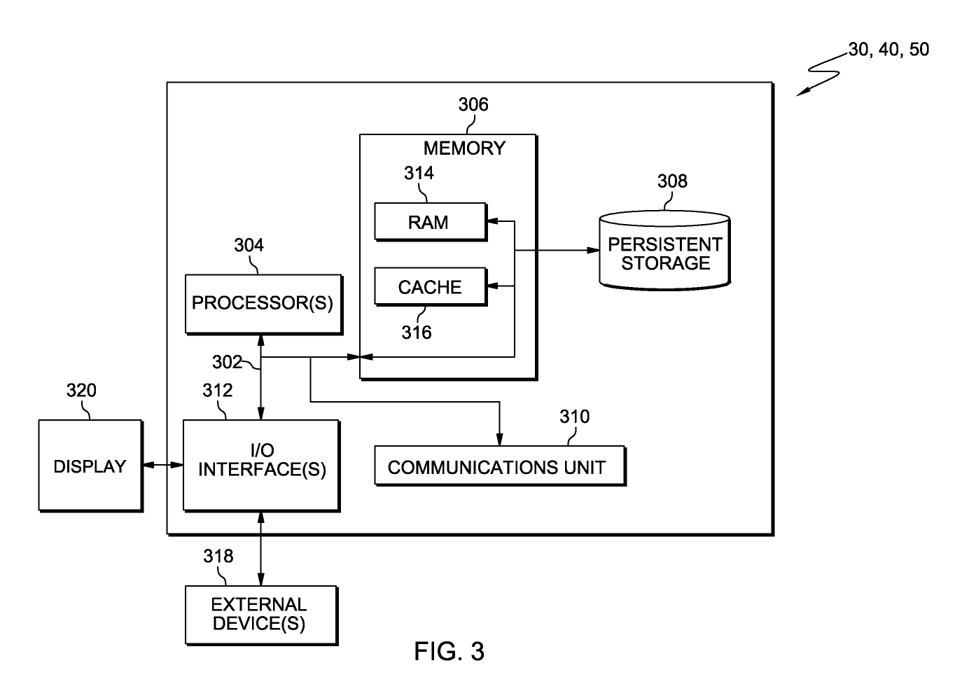

Mobile computing device 30 may be a smart phone, tablet computer, laptop computer, or personal digital assistant (PDA). In general, mobile computing device 30 may be any electronic device or computing system capable of sending and receiving data, and communicating with cloud server 50 over MNO network 25. In the depicted embodiment, mobile computing device 30 contains user interface 60 and secure local storage 70. In one embodiment, mobile computing device 30 can include components described in reference to FIG. 3.

Application provider 40 may be a management server, a web server, or any other electronic device or computing system capable of receiving and sending data. In another embodiment, application provider 40 may represent a server computing system utilizing multiple computers as a server system, such as in a cloud computing environment. In the depicted embodiment, application provider 40 includes application distribution program 80 and application data allocation program 90. In one embodiment, application provider 40 can include components described in reference to FIG. 3.

Cloud server 50 may be a management server, a web server, or any other electronic device or computing system capable of receiving and sending data. In another embodiment, cloud server 40 may represent a server computing system utilizing multiple computers as a server system, such as in a cloud computing environment. Cloud server 50 includes cloud storage 100 and trusted services manager program 110. In one embodiment, cloud server 50 can include components described in reference to FIG. 3.

User Interface (UI) 60 operates on mobile computing device 30 to visualize content, such as menus and icons, and to allow a user to interact with an application accessible to mobile computing device 30. For example, UI 60 can allow a user operating mobile computing device 30 to interact with application distribution program 80, application data allocation program 90, and trusted services manager program 110. In another embodiment, UI 60 may comprise one or more interfaces such as an operating system interface and/or application interfaces.

Secure local storage 70 is a repository that may be written and read by software (not shown) on mobile computing device 30 and is accessible to applications (not shown) that reside on mobile computing device 30. For example, secure local storage 70 is a smart card chip, or secure element, that is capable of embedding near field communication (NFC) applications with the required level of security and features. Secure local storage 70 is capable of embedding contactless and NFC-related applications and is connected to NFC chip 65 acting as the contactless front end. In one embodiment, secure local storage 70 can be integrated in an integrated circuit such as a subscriber identification module (SIM) card. In another embodiment, secure local storage 70 may be a removable device that is not permanently attached to mobile computing device 30. In yet another embodiment, secure local storage 70 permanently resides on mobile computing device 30.

In the depicted embodiment, secure local storage 70 operates to securely store one or more executable NFC applications (i.e. programs) and the application data for each of the one or more executable NFC applications on mobile computing device 30. An executable NFC application includes a sequence of encoded instructions written to perform a task on mobile computing device 30. Application data may be any data used by the executable NFC application that operates on mobile computing device 30, such as a list of applications the user has access to and the userids and passwords for the applications, and billing information for the application, such as a user's credit card number and checking account routing number.

Application distribution program 80 operates to receive and respond to requests for applications. In the depicted embodiment, application distribution program 80 operates to receive and respond to requests for near field communication (NFC) applications. In the depicted embodiment, in response to a user selecting an application for download, application distribution program 80 sends the executable application and application data to trusted services manager program 110 over network 20. In the depicted embodiment, application distribution program 80 also instructs application data allocation program 90 to send application allocation data for the application selected by the user to trusted services manager program 110.

Application data allocation program 90 operates to define and store application allocation data for any application available for download. Application data allocation program 90 also sends application allocation data for the application selected by the user to trusted services manager program 110. In the depicted embodiment, application data allocation program 90 receives an instruction from application distribution program 80 to send application allocation data for the application selected by the user to trusted services 110. In the depicted embodiment, application allocation data includes instructions describing how to allocate and store application data. For example, application allocation data includes instructions to store all application data on secure local storage 70. Alternatively, application allocation data includes instructions to store all application data on secure local storage 70, and store a copy of all application data on cloud storage 100. In another example, application allocation data includes instructions to store all application data on cloud storage 100. Alternatively, application allocation data includes instructions to store all application data on cloud storage 100, and store a copy of all application data on secure local storage 70.

In yet another example, application allocation data includes instructions to store a portion of the application data on secure local storage 70, and store the remaining portion of the application data on cloud storage 100. Alternatively, application allocation data includes instructions to store all application data on cloud storage 100, and only local stubs exist on mobile computing device 30. A local stub is a piece of code that is used to represent a programming functionality. A local stub may simulate the behavior of existing code (such as a procedure on a remote machine). The local stubs existing on mobile computing device 30 would provide the capability for offline access if network connectivity to cloud storage 100 is interrupted.

In another example, cloud storage 100 may function as the application data “master.” As the application data “master,” trusted services manager program 110 logs updates and automatically sends updates to secure local storage 70. Mobile computing device 30, upon receiving and storing an update to secure local storage 70, sends a message to trusted services manager program 110 indicating that the update was received. Alternatively, secure local storage 70 may function as the application data “master.” As the application data “master,” mobile computing device 30 logs updates and automatically sends updates to cloud storage 100. Trusted services manager program 110, upon receiving and storing an update to cloud storage 100, sends a message to mobile computing device 30 indicating that the update was received.

In another example, application data may be sent to more than one user operating more than one mobile device. The application data may be stored using any of the methods discussed in the previous examples, or a combination of the methods.

The developer of the application selected by the user will define the application allocation data governing the allocation of the application data. In other embodiments, the user may define the application allocation data if allowed by the developer. For example, the user, using mobile computing device 30, can access application data allocation program 90 and define application allocation data for the selected application.

Cloud storage 100 is a repository that may be written and read by trusted services manager program 110 on cloud server 50. Cloud storage 100 may also be accessed by UI 60 and software (not shown) on mobile computing device 30. Cloud storage 100 may be a removable device that is not permanently attached to cloud server 50. In another embodiment, cloud storage 100 permanently resides on cloud server 50. Cloud storage 100 operates to store application data and application allocation data. In the depicted embodiment, cloud storage 100 receives application data and application allocation data from TSM program 110.

Trusted services manager (TSM) program 110 operates to determine the allocation of the application data of the application selected for download by the user. In the depicted embodiment, the determination of application data allocation is based on application allocation data received from application data allocation program 90 and stored in cloud storage 100. TSM program 110 may also receive mobile identification data from application distribution program 80. Mobile identification data may be any data that identifies mobile computing device 30, such as a set of identification numbers. An identification number may include a personal identification number (PIN) for ordinary use and a personal unblocking code (PUK) for PIN unlocking, a unique serial number, security authentication and ciphering information, temporary information related to the network, etc. TSM program 110 uses the mobile identification data to determine where to send application data.

Based on the application allocation data, TSM program 110 allocates the application data accordingly. In one embodiment, TSM program 110 causes the application data to be stored on secure local storage 70. Alternatively, TSM program 110 causes the application data to be stored on cloud storage 100. In yet another embodiment, TSM program 110 causes a portion of the application data to be stored on secure local storage 70, and causes the remaining portion of application data to be stored on cloud storage 100.

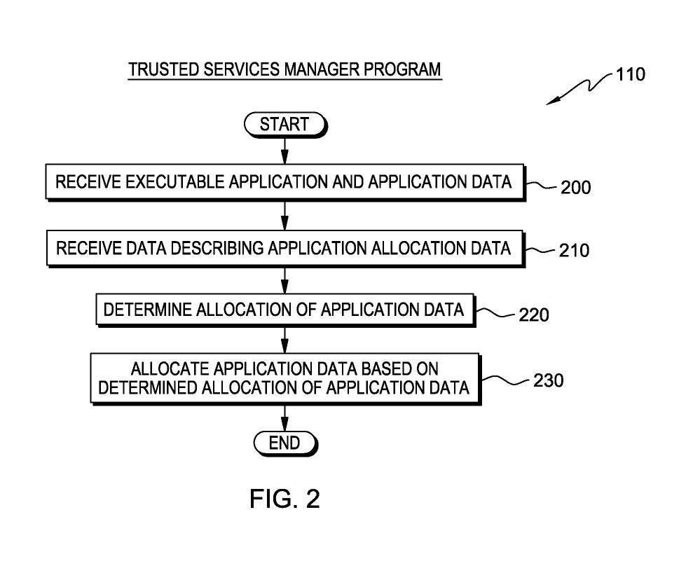

FIG. 2 depicts a flowchart of TSM program 110 for determining the allocation of application data of the application selected for download by a user, in accordance with one embodiment of the present invention.

Initially, a user operating mobile computing device 30, using user interface 60, accesses application distribution program 80 over network 20. The user selects an application for download from application distribution program 80. In the depicted embodiment, application distribution program 80 sends an executable application and application data for the selected application to TSM program 110 over network 20. Application distribution program 80 also sends an instruction to application data allocation program 90 to send application allocation data for the application selected by the user to TSM program 110. In another embodiment, application distribution program 80 accesses application data allocation program 90 to retrieve application allocation data, and application distribution program 80 sends the application allocation data to TSM program 110.

In step 200, TSM program 110 receives the executable application and application data for the application selected by the user. In the depicted embodiment, TSM program 110 receives all application data for the application selected by the user from application distribution program 80. TSM program 110 sends the executable application to mobile computing device 30 over MNO network 25 to be stored on secure local storage 70.

In step 210, TSM program 110 receives application allocation data for the application selected by the user. In the depicted embodiment, TSM program 110 receives application allocation data from application data allocation program 90. In another embodiment, TSM program 110 receives application allocation data from application distribution program 80. Alternatively, TSM program 110 accesses application data allocation program 90 over the network. TSM program 110 determines the application allocation data stored by application data allocation program 90 for the application selected by the user operating mobile computing device 30. In yet another embodiment, TSM program 110 accesses the mobile network operator to determine the application allocation data for the application selected by the user operating mobile computing device 30. TSM program 110 stores application allocation data to cloud storage 100.

In step 220, TSM program 110 determines the allocation of application data for the application selected by the user. TSM program 110 uses the application allocation data to determine how to allocate the application data of the application selected by the user. In the depicted embodiment, TSM program 110 calls cloud storage 100 to retrieve the application allocation data. The application allocation data contains instructions about how to allocate and store the application data for the application selected by the user.

In the depicted embodiment, TSM program 110 determines from the application allocation data that a portion of the application data must be stored on secure local storage 70, residing on mobile computing device 30, and the remaining application data is to be stored on cloud storage 100, residing on cloud server 50.

In step 230, TSM program 110 allocates the application data based on the determined allocation of application data. In the depicted embodiment, TSM program 110 causes the portion of the application data specified to be stored on secure local storage 70 by the application allocation data to be stored on secure local storage 70. For example, TSM program 110 sends the portion specified to be stored on secure local storage 70 to mobile computing device 30 over MNO network 25 to be stored on secure local storage 70. TSM program 110 also causes the portion of the application data specified to be stored on cloud storage 100 by the application allocation data to be stored on cloud storage 100. For example, TSM program 110 sends the portion specified to be stored on cloud storage 100 to cloud storage 100.

FIG. 3 depicts a block diagram of components of mobile computing device 30, application provider 40, and cloud server 50, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Mobile computing device 30, application provider 40, and cloud server 50 each include communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

UI 60 and secure local storage 70 are stored in persistent storage 408 of mobile computing device 30, respectively, for execution and/or access by one or more of the respective computer processors 304 of application provider 40 via one or more memories of memory 306 of mobile computing device 30. Application distribution program 80 and application data allocation program 90 are stored in persistent storage 308 of application provider 40, respectively, for execution by one or more of the respective computer processors 304 of application provider 40 via one or more memories of memory 306 of application provider 40. Cloud storage 100 and TSM program 110 are stored in persistent storage 308 of cloud server 50 for execution and/or access by one or more of the respective computer processors 304 of cloud server 50 via one or more memories of memory 306 of cloud server 50. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other servers or devices. In these examples, communications unit 310 includes one or more network interface cards. Communications unit 310 may provide communications through the use of either or both physical and wireless communications links. UI 60 and secure local storage 70 may be downloaded to persistent storage 308 of mobile computing device 30, respectively, through the respective communications unit 310 of mobile computing device 30. Application distribution program 80 and application data allocation program 90 may be downloaded to persistent storage 308 of application provider 40, respectively, through the respective communications unit 310 of application provider 40. Cloud storage 100 and TSM program 110 may be downloaded to persistent storage 308 of cloud server 50, respectively, through the respective communications unit 310 of cloud server 50.

I/O interface(s) 312 allows for input and output of data with other devices that may be connected to application provider 40 and cloud server 50. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., UI 60 and secure local storage 70 can be stored on such portable computer-readable storage media and can be loaded onto persistent storage 308 of mobile computing device 30, respectively, via the respective I/O interface(s) 312 of mobile computing device 30. Software and data used to practice embodiments of the present invention, e.g., application distribution program 80 and application data allocation program 90 can be stored on such portable computer-readable storage media and can be loaded onto persistent storage 308 of application provider 40, respectively, via the respective I/O interface(s) 312 of application provider 40. Software and data used to practice embodiments of the present invention, e.g., cloud storage 100 and TSM program 110 can be stored on such portable computer-readable storage media and can be loaded onto persistent storage 308 of cloud server 50, respectively, via the respective I/O interface(s) 312 of cloud server 50. I/O interface(s) 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1-8. (canceled)

9. A computer program product for allocating and storing application data for applications of mobile devices, the computer program product comprising:
one or more computer-readable storage media and program instructions stored on the one or more computer-readable storage media, the program instructions comprising:
program instructions to receive one or more portions of application data of an application selected by a user of a mobile computing device;
program instructions to determine where to store each of the one or more portions of application data based on predefined instructions; and
program instructions to cause each of the one or more portions of application data to be stored based on the determination.

10. The computer program product of claim 9, wherein the predefined instructions include instructions to store each of the one or more portions of application data on the mobile computing device.

11. The computer program product of claim 9, wherein the predefined instructions include instructions to store each of the one or more portions of application data on a cloud computing device.

12. The computer program product of claim 9, wherein the predefined instructions include instructions to store each of the one or more portions of application data on the mobile computing device and instructions to store a copy of each of the one or more portions of application data on the cloud computing device.

13. The computer program product of claim 9, wherein the predefined instructions include instructions to store each of the one or more portions of application data on the cloud computing device and instructions to store a copy of each of the one or more portions of application data on the mobile computing device.

14. The computer program product of claim 9, wherein the predefined instructions include instructions to store one or more portions of application data on the cloud computing device and instructions to store one or more different portions of the application data on the mobile computing device.

15. The computer program product of claim 9, wherein the predefined instructions include instructions to store the one or more portions of application data in a master-slave mode between the mobile computing device and the cloud computing device.

16. The computer program product of claim 9, further comprising program instructions, stored on the one or more computer-readable storage media, to send an executable application of the selected application to the mobile computing device.

17. A computer system for allocating and storing application data for applications of mobile devices, the computer system comprising:
one or more computer processors;
one or more computer-readable storage media;
program instructions stored on the computer-readable storage media for execution by at least one of the one or more processors, the program instructions comprising:
program instructions to receive one or more portions of application data of an application selected by a user of a mobile computing device;
program instructions to determine where to store each of the one or more portions of application data based on predefined instructions; and
program instructions to cause each of the one or more portions of application data to be stored based on the determination.

18. The computer system of claim 17, wherein the predefined instructions include instructions to store each of the one or more portions of application data on the mobile computing device.

19. The computer system of claim 17, wherein the predefined instructions include instructions to store each of the one or more portions of application data on a cloud computing device.

20. The computer system of claim 17, wherein the predefined instructions include instructions to store one or more portions of application data on the cloud computing device and instructions to store one or more different portions of the application data is to be stored on the mobile computing device.
